(19) United States
(12) Patent Application Publication
(10) Pub. No.: US 2010/0257271 A1
(43) Pub. Date: Oct. 7, 2010

(54) INFORMATION PROCESSING APPARATUS, DEVICE, CONTROL METHOD OF INFORMATION PROCESSING APPARATUS, AND STORAGE MEDIUM

(75) Inventors: Tadahiro Nakamura, Yokohama-shi (JP); Masahiro Nishio, Higashiyamato-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/739,913

(22) PCT Filed: Nov. 20, 2008
(86) PCT No.: PCT/JP2008/071599

§ 371 Date: Apr. 26, 2010

(30) Foreign Application Priority Data
Dec. 21, 2007 (JP) 2007-330953

(51) Int. Cl. G06F 15/16

(52) U.S. Cl. 709/226

(57) ABSTRACT

An information processing apparatus comprises: a management unit adapted to manage plural network addresses; an allocation unit adapted to, according to a request from an apparatus newly connected to a network, allocate, from among the network addresses managed by the management unit, the network address not allocated to other apparatus; a storage unit adapted to store the network address of a search server of performing a search according to a search request for searching for a device on the network and of responding to the search request by a searched result; and a transmission unit adapted to transmit the network address allocated by the allocation unit and the network address stored in the storage unit to the apparatus.

### TECHNICAL FIELD

The present invention relates to an information processing apparatus, a device, and a control method of the information processing apparatus, which are used in a network system for searching for a device on a network.

### BACKGROUND ART

Conventionally, a device such as a printer or the like which is connected on a network can be used by a client PC (personal computer) via the network. At that time, it is necessary for the client PC to first find the intended device on the network, and then install the driver software for using the found device. Here, there are several techniques for searching for the device on the network. One of these techniques is to transmit a search request packet by using broadcasting or multicasting. Here, it should be noted that the broadcasting and the multicasting are widely and generally known as methods of transmitting data to plural devices provided on a network. In such device search techniques as described above, the client PC transmits the search request packet by using the broadcasting or the multicasting, and the device which received the search request packet transmits a search response packet to the client PC, whereby the client PC searches for the device.

Further, it is possible to constitute a large-scale network by mutually connecting plural small-scale networks via a connection device such as a router or the like. In the large-scale network like this, since the broadcasting and the multicasting generally affect entire traffic of the network, the router is often used in such a setting of invalidating the broadcasting and the multicasting. The network which has been partitioned by the router is called a subnet, and the broadcasting and the multicasting are generally used only in each subnet. If a network device search technique using the broadcasting and/or the multicasting is applied to such a circumstance, a search request packet transmitted by a client PC cannot pass the router. Consequently, in the network circumstance in which the plural subnets are mutually connected via the router, it is impossible for the client PC of one subnet to find a device existing in another subnet.

To solve such a problem as described above, Japanese Patent Application Laid-Open No. 2007-097057 proposes a technique of providing a server for each subnet and thus exchanging device information and search requests among the respective servers.

In the above-described conventional technique, to make an inquiry to a server, a client PC has to previously know the network address of the relevant server. In other words, a user has to previously register the network address of the relevant server to each client PC. Further, it is necessary to previously register information of devices on the network. Therefore, it is troublesome for the user, a system administrator and the like to perform such registration operations, since the number of servers increases if the number of subnets increases and an operation load increases according as the numbers of devices and client PCs increase.

### DISCLOSURE OF THE INVENTION

The present invention has been completed in consideration of such conventional problems as described above, and thus aims to reduce, in a case where a search server for searching for a device is set, troublesomeness of setting operations for the purpose of use of the search server by the client PC and the device.

According to a first aspect of the present invention, there is provided an information processing apparatus which comprises: a management unit adapted to manage plural network addresses; an allocation unit adapted to, according to a request from an apparatus newly connected to a network, allocate, from among the network addresses managed by the management unit, the network address not allocated to other apparatus; a storage unit adapted to store the network address of a search server of performing a search according to a search request for searching for a device on the network and of responding to the search request by a searched result; and a transmission unit adapted to transmit the network address allocated by the allocation unit and the network address stored in the storage unit to the apparatus.

According to a second aspect of the present invention, there is provided a device, connected to a network, which comprises: a transmission unit adapted to transmit a request on the network so as to acquire a network address of the device from an information processing apparatus provided on the network; a reception unit adapted to receive, from the information processing apparatus, the network address of the device and a network address of a search server of performing a search according to a search request for searching for the device on the network and of responding to the search request by a searched result; and a second transmission unit adapted to transmit device information of the device itself to the search server, based on the network address of the search server received by the reception unit.

According to a third aspect of the present invention, there is provided an information processing apparatus, connected to a network, which comprises: a transmission unit adapted to transmit a request on the network so as to acquire a network address of the information processing apparatus from a server provided on the network; a reception unit adapted to receive, from the server, the network address of the information processing apparatus and a network address of a search server of performing a search according to a search request for searching for a device on the network and of responding to the search request by a searched result; and a second transmission unit adapted to transmit the search request to the search server based on the network address of the search server received by the reception unit.

Other features, objects and advantages of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate the exemplary first embodiments of the present invention and, together with the description, serve to explain the principles of the present invention.

FIG. 1 is a diagram illustrating a configuration of a network device search system according to the first embodiment of the present invention.

FIG. 2 is a sequence diagram for describing a flow of a DHCP (Dynamic Host Configuration Protocol) message to be exchanged between a DHCP server and a DHCP client.

FIG. 3 is a diagram illustrating the format of the DHCP message.

FIG. 4 is a block diagram illustrating a hardware constitution of an image forming apparatus.

FIG. 5 is a block diagram illustrating software constitutions of the DHCP server, a DP (Discovery Proxy), a client PC and the image forming apparatus.

FIG. 6 is a diagram illustrating an example of device information to be held by a device information holding unit of the DP.

FIG. 7 is a diagram illustrating an example of a Hello message according to the first embodiment.

FIG. 8 is a diagram illustrating an example of a Get message according to the first embodiment.

FIG. 9 is a diagram illustrating an example of a Get Response message according to the first embodiment.

FIG. 10 is a diagram illustrating an example of a Bye message according to the first embodiment.

FIG. 11 is a diagram illustrating an example of a Probe message according to the first embodiment.

FIG. 12 is a diagram illustrating an example of a Probe Match message according to the first embodiment.

FIG. 13 is a diagram illustrating an example of a UI (user interface) in a case where the client PC searches for the image forming apparatus.

FIG. 14 is a flow chart illustrating a process to be performed in a case where the DP registers device information.

FIG. 15 is a flow chart illustrating a process to be performed in a case where the DP deletes the device information.

FIG. 16 is a flow chart illustrating a process to be performed in a case where the DP searches for the device information.

FIG. 17 is a block diagram illustrating software constitutions of a DHCP server, a DP, a client PC and an image forming apparatus according to the second embodiment.

FIG. 18 is a diagram illustrating a format of notification data to be transmitted from the DHC server to the DP.

FIG. 19 is a flow chart illustrating a process to be performed in a case where a distribution situation reception unit of the DP receives a notification from the DHCP server.

FIG. 20 is a diagram illustrating a configuration of a network device search system according to the third embodiment.

FIG. 21 is a diagram illustrating an example of setting information to be held in a distribution information DB (data base) according to the first embodiment.

FIG. 22 is a flow chart illustrating a process to be performed in a case where the DHCP server according to the first embodiment distributes the setting information.

FIG. 23 is a flow chart illustrating a process to be performed in a case where the DHCP server identifies the setting information.

FIG. 24 is a diagram illustrating an example of an options field of a DHCP REQUEST message.

FIG. 25 is a diagram illustrating an example of an options field of a DHCP ACK message.

FIG. 26 is a diagram illustrating an example of setting information to be held in a distribution information DB according to the third embodiment.

FIG. 27 is a flow chart illustrating a process to be performed in a case where the DHCP server according to the third embodiment distributes the setting information.

FIG. 28 is a block diagram illustrating a software constitution of the DP according to the second embodiment.

FIG. 29 is a flow chart illustrating a process to be performed in a case where a distribution situation reception unit of the DP receives a notification from the DHCP server.

FIG. 30 is a block diagram illustrating hardware constitutions of a DHCP server, a DP and a client PC.

### BEST MODE FOR CARRYING OUT THE INVENTION

### First Embodiment

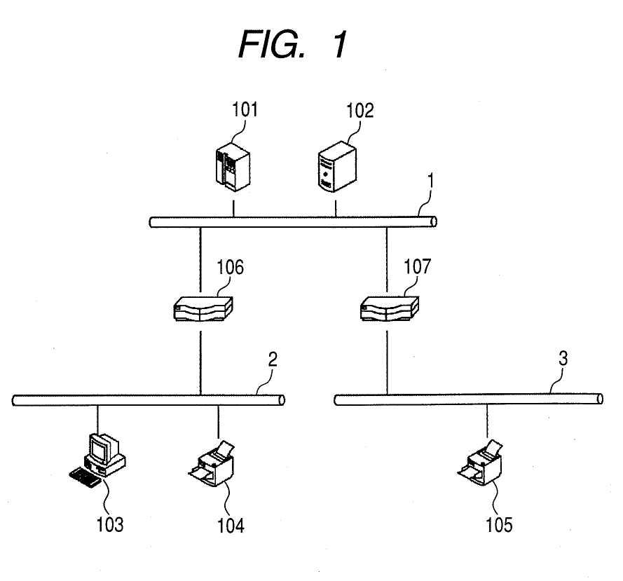

FIG. 1 is a diagram illustrating a configuration of a network device search system to which the present invention is applied.

The network device search system includes a subnet 1 to which a DHCP server 101 and a DP (Discovery Proxy) 102 acting as a search server are connected, a subnet 2 to which a client PC 103 and an image forming apparatus 104 are connected, and a subnet 3 to which an image forming apparatus 105 is connected. Further, the subnet 1 and the subnet 2 are mutually connected to each other via a router 106, the subnet 1 and the subnet 3 are mutually connected to each other via a router 107, and one LAN (local area network) is constituted by the subnets 1, 2 and 3. Thus, all the terminals connected to the subnets 1, 2 and 3 can mutually communicate resultingly. However, each of the routers 106 and 107 does not pass broadcasting and multicasting from one subnet to the other subnet. Consequently, communication by use of broadcasting and/or multicasting can be performed only within each subnet. Here, it should be noted that each of the image forming apparatuses 104 and 105, which is an example of the device in the present invention, is a printer, a copying machine, a scanner, a multifunctional machine, a facsimile machine, or the like. Also, it should be noted that, as described later, a general-purpose PC can be used as each of the DHCP server 101, the DP 102 and the client PC 103, which is an example of the information processing apparatus in the present invention. In the network device search system illustrated in FIG. 1, a search request packet is transmitted from the client PC 103 to the DP 102 so that a user who operates the client PC 103 searches for a desired image forming apparatus (device). Then, the device is searched by the DP 102, and a searched result is returned to the client PC 103.

Subsequently, a method of distributing setting information such as an IP (Internet Protocol) address and the like by using a DHCP (Dynamic Host Configuration Protocol) will be described. The DHCP is the protocol in which a scheme for distributing setting information to respective terminals connected to a network, and the detail of the DHCP has been defined by the RFC2131 (Request For Comment 2131). The DHCP adopts a client/server method, the DHCP server unitarily controls various kinds of setting information, and a network terminal acting as the DHCP client receives the setting information.

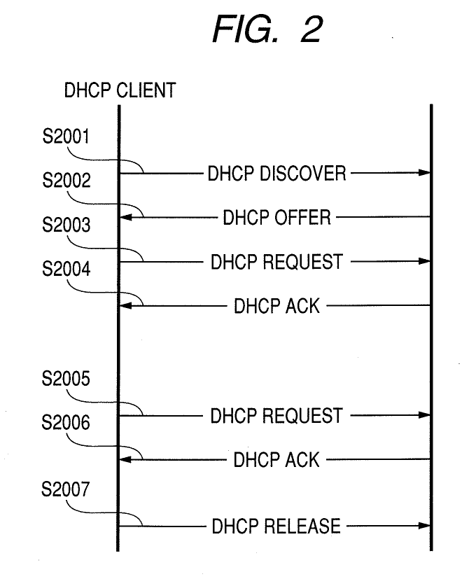

FIG. 2 is a sequence diagram for describing a flow of a DHCP message to be exchanged between the DHCP server and the DHCP client. First, the DHCP client broadcasts a DHCP DISCOVER message (S2001). The DHCP server, which received the DHCP DISCOVER message, allocates an IP address to the DHCP client which transmitted the DHCP DISCOVER message, and then transmits a DHCP OFFER message to the DHCP client (S2002). Here, it should be noted that the DHCP OFFER message includes the IP address allocated to the DHCP client which transmitted the DHCP DISCOVER message, and other setting information.

The DHCP client, which received the DHCP OFFER message, broadcasts a DHCP REQUEST message for using the IP address included in the DHCP OFFER message (S2003). Then, the DHCP server, which received the DHCP REQUEST message, transmits a DHCP ACK message (S2004). Subsequently, the DHCP client, which received the DHCP ACK message, performs network communication by using the distributed IP address and the distributed setting information.

Besides, an available period (lease time) has been set to the IP address distributed by the DHCP server. Therefore, if the DHCP client wishes to continuously use the acquired IP address after the lease time, the DHCP client transmits the DHCP REQUEST message to the DHCP server before the lease time lapses (S2005). The DHCP server, which received the DHCP REQUEST from the DHCP client at the already-allocated IP address, updates the lease time for the relevant IP address, and again transmits the DHCP ACK message to the relevant DHCP client (S2006).

If the DHCP client stops using the IP address, the DHCP client transmits a DHCP RELEASE message to the DHCP server (S2007). The DHCP server, which received the DHCP RELEAASE message, releases the allocation of the relevant IP address, and enables to allocate the relevant IP address to another DHCP client.

Further, if the DHCP server does not receive the DHCP REQUEST message from the DHCP client at the already-allocated IP address and then the lease time lapses, the DHCP server releases the allocation of the relevant IP address. Then, the DHCP server enables to allocate the relevant IP address to another DHCP client.

Incidentally, in the flow illustrated in FIG. 2, the messages S2001 to S2004 are transmitted by broadcasting. This is because, at this moment, an IP address is not determined for the DHCP client.

On the other hand, in the network in which the plural subnets are connected via the routers as illustrated in FIG. 1, if it is set that the router does not pass the broadcasting, the DHCP messages as illustrated in FIG. 2 are interrupted by the router. To solve such a problem, the RFC2131 also describes a specification of a relay agent. Here, it should be noted that the relay agent is generally provided as one function of the router, and the operation of the relay agent will be concisely described with reference to FIG. 1.

First, the router 106 having the relay agent function has previously stored the IP address of the DHCP server 101. Then, the client PC 103 acting as the DHCP client broadcasts the DHCP DISCOVER message and the DHCP REQUEST message to the subnet 2. If the router 106 receives the DHCP DISCOVER message and the DHCP REQUEST message, the router 106 transfers these messages in unicast to the DHCP server 101 which has previously stores these messages. If the DHCP server 101 receives the DHCP DISCOVER message and the DHCP REQUEST message in unicast from the router 106, the DHCP server 101 transmits the DHCP OFFER message and the DHCP ACK message in unicast to the router 106. Then, if the router 106 receives the DHCP OFFER message and the DHCP ACK message from the DHCP server 101, the router 106 broadcasts these messages to the subnet 2.

As just described, since the router having the relay agent function receives the broadcasted DHCP message and transfers this message in unicast to the DHCP server, the DHCP client comes to be able to receive the information from the DHCP server.

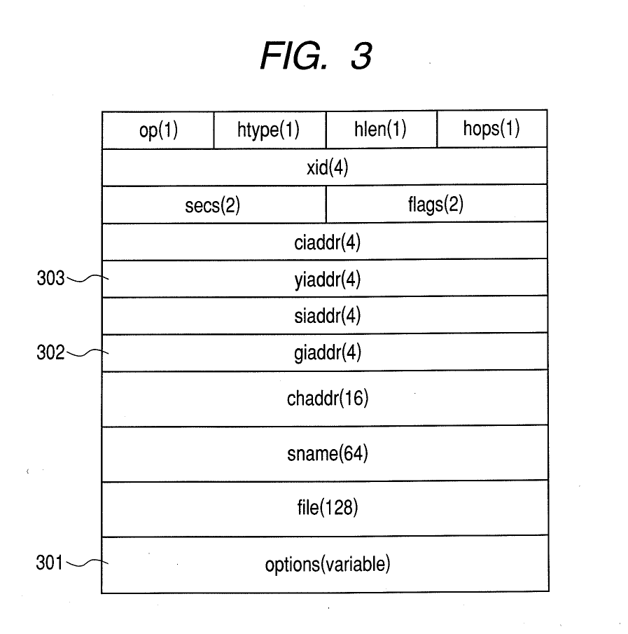

FIG. 3 is a diagram illustrating the format of the DHCP message. In FIG. 3, an options field 301 is the area to which various variable-length data can be set. Here, plural options data each of which consists of a one-byte tag, a one-byte data size and variable-length data can be set to this area. Further, the value of the tag may be a previously standardized value or a value which can be expanded by a vendor. For example, the value of the tag such as subnet mask, an IP address of a DNS (Domain Name System) server, or the like is widely used as the standardized value.

In the present embodiment, the options field 301 is expanded and used. If the tag representing the IP address of the DP is defined and the IP address of the DP is set as the data, the IP address information of the DP can be distributed to the DHCP clients such as the client PC, the device and the like by using the DHCP. Further, in a case where the plural DPs exist on the network, if the IP addresses of the plural DPs are set in the options field 301, the IP address information of these DPs can be distributed.

Further, in a case where the relay agent transfers the DHCP message to the DHCP server, the IP address of the relay agent itself is set to a giaddr field 302. Thus, in a case where the DHCP server receives the DHCP message, if the received DHCP message is the message transmitted from the relay agent, the DHCP server can identify the subnet to which the DHCP client belongs, by confirming the giaddr field 302. Furthermore, the IP address to be allocated by the DHCP server to the DHCP client is set to a yiaddr field 303.

Subsequently, in the configuration of the network device search system illustrated in FIG. 1, the hardware and software constitutions of the DHCP server 101, the DP 102, the client PC 103 and the image forming apparatuses 104 and 105, which are relative to the present invention, will be described. Incidentally, it should be noted that, in the following description, the numeral 104 is used as the representative of the image forming apparatus unless otherwise noted.

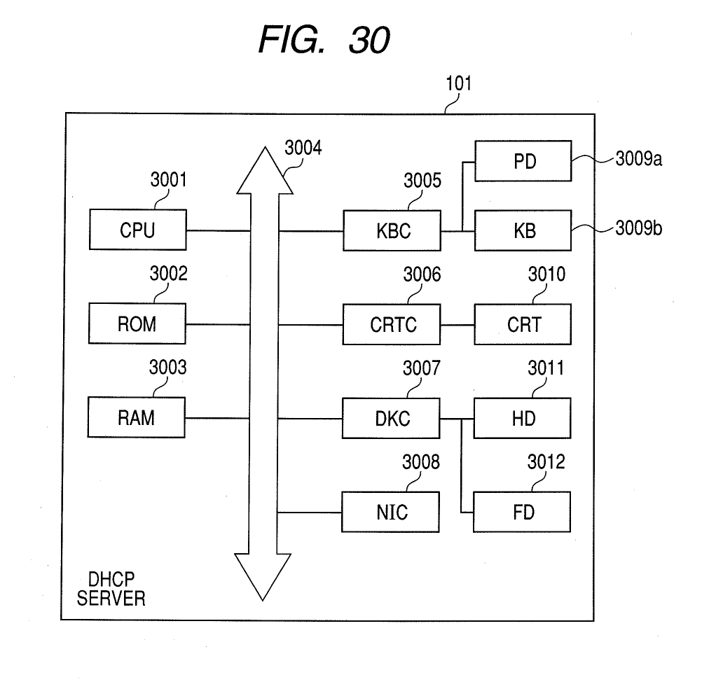

FIG. 30 is a block diagram illustrating the hardware constitutions of the DHCP server 101, the DP 102 and the client PC 103. Incidentally, it should be noted that general-purpose PCs (personal computers) can be used as the DHCP server 101, the DP 102 and the client PC 103, and the following description will be common to these PCs.

In FIG. 30, a CPU (central processing unit) 3001 controls various devices which are connected to a system bus 3004. A ROM (read only memory) 3002 stores therein a BIOS (Basic Input/Output System) and a boot program, and a RAM (random access memory) 3003 is used as a main memory for the CPU 3001. A KBC (keyboard controller) 3005 performs processes concerning inputting of information and the like from a PD (pointing device) 3009a such as a mouse or the like and a KB (keyboard) 3009b. A CRTC (cathode ray tube controller: display control unit) 3006, which contains a video memory therein, performs drawing on the video memory according to an instruction from the CPU 3001, and outputs image data drawn on the video memory to a CRT (cathode ray tube: display unit) 3010 as a video signal. Incidentally, although the CRT is used as an example of the display unit in FIG. 30, other kinds of display units such as an LCD (liquid crystal display) unit and the like may be used. A DKC (disk controller) 3007 accesses an HD (hard disk) 3011 and an FD (floppy disk) 3012. An NIC (network interface card) 3008, which is connected to the network, performs information communication via the network. Incidentally, it should be noted that an OS (operating system), various application programs operating on the OS, and the like are stored in the HD 3011. In the above constitution, if the power supply of the hardware constitution itself is turned on, the CPU 3001 reads the OS from the HD 3011 to the RAM 3003 according to the boot program stored in the ROM 3002, whereby the hardware constitution resultingly functions as the information processing apparatus.

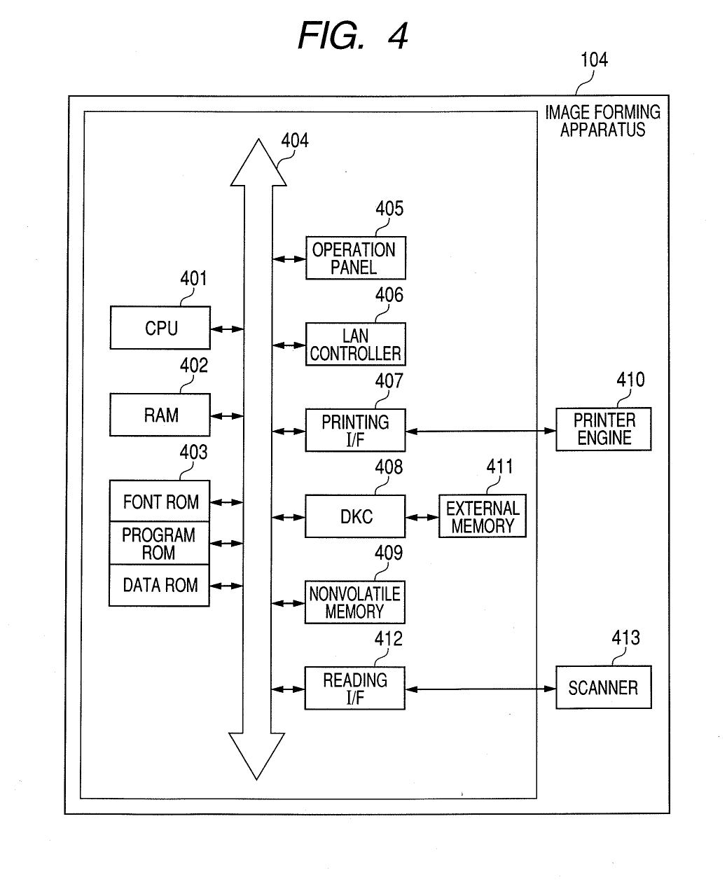

FIG. 4 is a block diagram illustrating the hardware constitution of the image forming apparatus 104. Incidentally, in the present embodiment, it is assumed that the image forming apparatus 104 is equivalent to an MFP (Multi Function Peripheral) 104. In the MFP 104 illustrated in FIG. 4, a CPU 401 unitarily controls accessing to various devices connected to a system bus 404 on the basis of control programs stored in a program ROM of a ROM 403. Further, the CPU 401 outputs an image signal functioning as output information to a printer engine (printing unit) 410 connected via a printing I/F (interface) 407, and controls an image signal input from a scanner (reading unit) 413 connected via a reading I/F 412. Incidentally, it should be noted that the control programs and the like capable of being performed by the CPU 401 are stored in the program ROM of the ROM 403, font data (including outline font data) and the like to be used in case of generating the output information are stored in a font ROM of the ROM 403, and various information and the like to be used on a host computer are stored in a data ROM of the ROM 403. The CPU 401 can perform a communication process to the host computer and the image forming apparatus on the network via a LAN controller 406. Further, a RAM 402 functions mainly as a main memory, a working area and the like for the CPU 401, and the capacity of the RAM 402 can be expanded by means of an option RAM connected to a not-illustrated expansion port. Incidentally, the RAM 402 is used as an output information extraction area, an environmental data storage area and the like. Incidentally, accessing to an external memory 411 such as an HD (hard disk), an IC (integrated circuit) card or the like is controlled by a DKC (disk controller) 408. Further, the HD is used as a job storage area for storing fond data, emulation programs, form data and the like, temporarily spooling a print job, and externally controlling the spooled job. Also, the HD is used as a BOX data storage area for storing the image data read from the scanner 413, the image data of the print job, and the like as BOX data so as to be referred and printed from the network. On an operation panel 405, a user can input various information via software keys. Here, it should be noted that the number of external memory is not limited to one. That is, at least one or more external memories can be provided in the present embodiment. More specifically, if the user intends to use an option font in addition to a built-in font, he/she can connect an option font card storing therein the option font. Further, if the user intends to use programs for interpreting printer control languages of different language systems, he/she can connect plural external memories respectively storing these languages. Incidentally, a nonvolatile memory 409 stores therein various setting information set from the operation panel 405. Although it is not illustrated in FIG. 4, various expansion devices such as a finisher for performing a stapling function, a sorting function and the like, a double-sided printing device for achieving a double-sided printing function, and the like can optionally be mounted to the MFP 104. In this case, the CPU controls the operations of these devices.

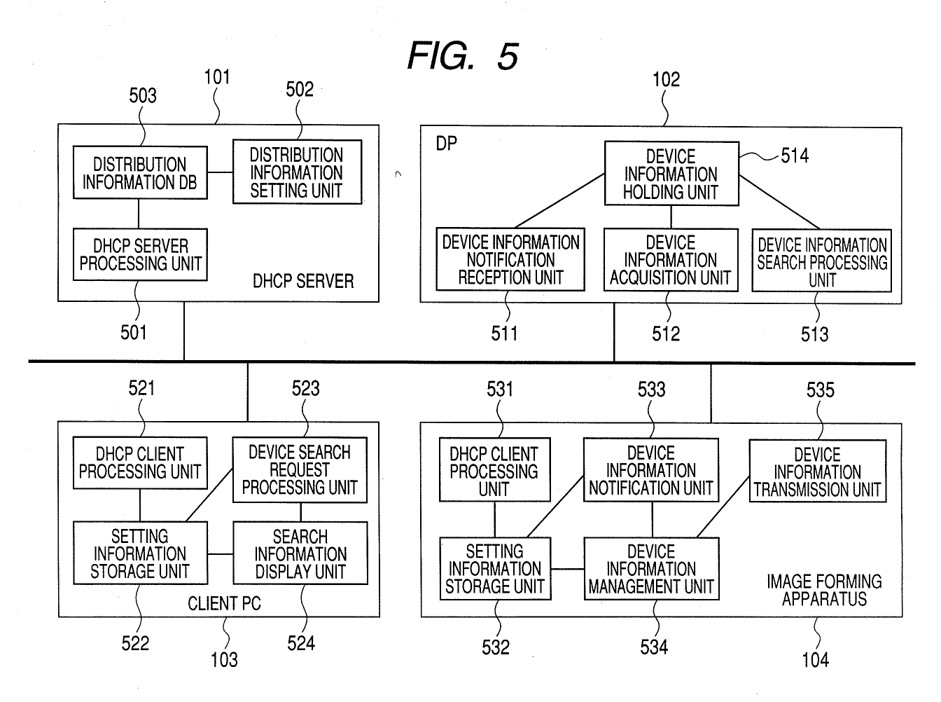

FIG. 5 is a block diagram illustrating software constitutions of the DHCP server 101, the DP 102, the client PC 103 and the image forming apparatus 104. In the DHCP server 101, a DHCP server processing unit 501 performs a process as the above-described DHCP server. More specifically, in response to a request from the DHCP client, the DHCP server processing unit 501 performs a process of allocating an IP address to the DHCP client, and a process of distributing the allocated IP address to the DHCP client. Here, a list of the IP addresses to be distributed to the DHCP client and setting information are held in a distribution information DB 503. Incidentally, although the client PC 103 or the image forming apparatus 104 acts as the DHCP client in the present embodiment, the DP 102 may act as the DHCP client. In response to the request from the DHCP client, the DHCP server processing unit 501 distributes various information as referring to the distribution information DB 503. A distribution information setting unit 502 sets the information to be held in the distribution information DB 503. Here, it should be noted that the distribution information setting unit 502 can set the information to be distributed to every subnet to which the DHCP client belongs, or to every client.

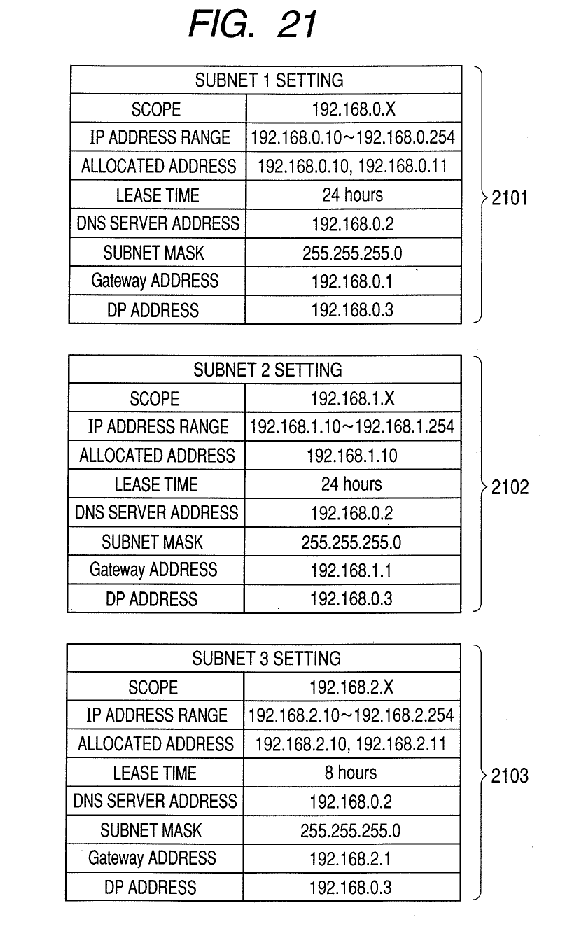

FIG. 21 is a diagram illustrating an example of the setting information to be held in the distribution information DB 503. More specifically, FIG. 21 illustrates a setting 2101 for the subnet 1 (also called subnet 1 setting 2101), a setting 2102 for the subnet 2 (also called subnet 2 setting 2102) and a setting 2103 for the subnet 3 (also called subnet 3 setting), so that it is possible to distribute different setting information to each subnet. Here, each of the setting information includes a scope, an IP address range, an allocated IP address, a lease time, a DNS server address, a subnet mask, a Gateway address, and a DP address. In the present embodiment, the DP addresses of the respective settings are all set to the IP address of the DP 102.

In the DP 102, a device information notification reception unit 511 receives a notification of a registration request, an update request or a deletion request of device information from the image forming apparatus 104, and performs a process of the device information held by a device information holding unit 514 on the basis of the kind of received notification. Then, if it is judged as the result of the process that it is necessary to acquire the device information, a device information acquisition unit 512 transmits a device information acquisition request to the image forming apparatus 104, and holds the returned device information in the device information holding unit 514. Subsequently, a device information search processing unit 513 receives a device information search request from the client PC 103, searches for the device information in the device information holding unit 514 on the basis of the designated search condition. Then, the device information search processing unit 513 transmits a searched result to the client PC 103. Here, it should be noted that the device information held by the device information holding unit 514 will be described later.

In the client PC 103, a DHCP client processing unit 521 performs the above-described process as the DHCP client. Since the IP address and various setting information delivered from the DHCP server are held and stored in a setting information storage unit 522, the user can appropriately refer to and use them. A device search request processing unit 523 transmits a device search request to the DP 102, and a search information display unit 524 displays a result thereof.

In the image forming apparatus 104, a DHCP client processing unit 531 performs the above-described process as the DHCP client. Since the IP address and various setting information delivered from the DHCP server are held and stored in a setting information storage unit 532, the user can appropriately refer to and use them. A device information management unit 534 manages the device information of the image forming apparatus 104 itself. A device information notification unit 533 transmits a registration request, an update request or a deletion request of the device information to the DP 102 if a notification of the device information is necessary. Then, if a device information acquisition request is received via the network, a device information transmission unit 535 transmits to the request source the device information managed by the device information management unit 534.

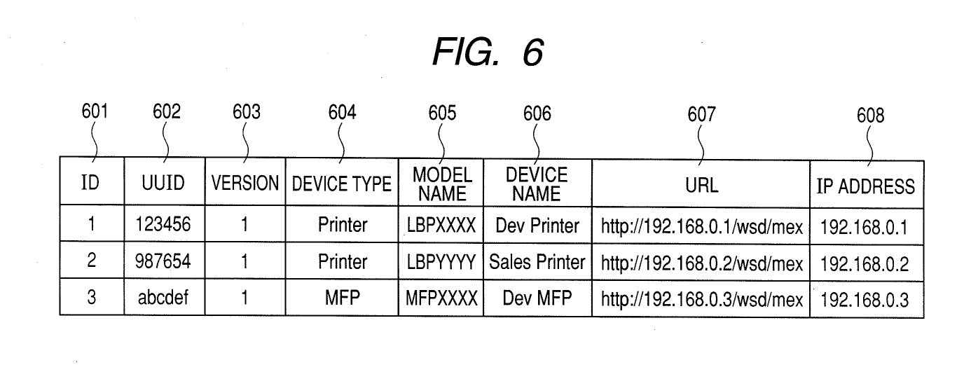

FIG. 6 is a diagram illustrating an example of the device information to be held by the device information holding unit 514 of the DP 102.

In FIG. 6, the information concerning each of the respective devices is held as a record which consists of an ID (identifier) 601, a UUID (Universally Unique Identifier) 602, a version 603, a device type 604, a model name 605, a device name 606, a URL (Uniform Resource Locator) 607, and an IP (Internet Protocol) address 608.

The ID 601 indicates an ID for identifying the device in the DP, the UUID 602 indicates a UUID for globally identifying the device, and the version 603 indicates a version of the device information. The device type 604 indicates a type of the device such as “MFP” implying a multifunction peripheral, “Printer” implying a printer, or the like. The model name 605 indicates a model name of the device such as “LBP XXXX” or the like. The device name 606 indicates a name which is set to the device by a device manager, the URL 607 indicates a URL for acquiring the device information, and the IP address 608 indicates an IP address of the device.

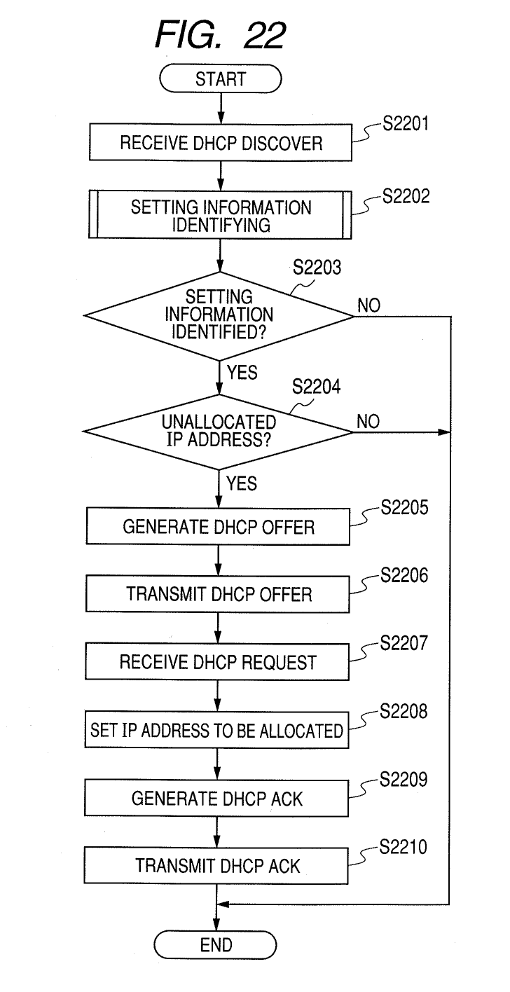

Subsequently, a process to be performed in a case where the DHCP server 101 distributes the setting information such as the IP address and the like to the DHCP client will be described with reference to a flow chart illustrated in FIG. 22. Here, it should be noted that the respective steps of the flow chart illustrated in FIG. 22 are performed if the CPU 3001 of the DHCP server processes the program stored in the ROM 3002.

Initially, in a step S2201, the DHCP DISCOVER message transmitted by the DHCP client or the relay agent is received via the NIC 3008. Then, in a step S2202, the setting information to be allocated to the DHCP client is identified by the CPU 3001 in a later-described method.

In a step S2203, it is judged by the CPU 3001 whether or not the setting information is identified by the process in the step S2202. If it is judged that the setting information is not identified, the process ends. On the other hand, if it is judged that the setting information is identified, the flow advances to a step S2204 to further judge whether or not an unallocated IP address (that is, the IP address which is not yet allocated) remains in the identified setting information. Then, if it is judged that the unallocated IP address does not remain, the process ends. On the other hand, if it is judged that the unallocated IP address remains, the flow advances to a step S2205 to generate the DHCP OFFER message. At that time, the IP address to be distributed is set to the yiaddr field 303 in FIG. 3. Further, the IP address of the DHCP server itself and the lease time are set as other information to the options field 301. Then, in a step S2206, the generated DHCP OFFER message is transmitted to the DHCP client via the NIC 3008.

In a step S2207, the DHCP REQUEST message transmitted by the DHCP client or the relay agent is received via the NIC 3008. The IP address set in the yiaddr field of the DHCP OFFER message is included in the options field 301 of the DHCP REQUEST message. Then, in a step S2208, it is set by the CPU 3001 that the corresponding IP address in the distribution information DB 503 has been allocated. Next, in a step S2209, the request option further included in the options field 301 of the DHCP REQUEST message is confirmed by the CPU 3001, and the DHCP ACK message to which the requested option information is set is generated by referring to the distribution information DB 503. Subsequently, the generated DHCP ACK message is transmitted to the DHCP client via the NIC 3008, and the process ends.

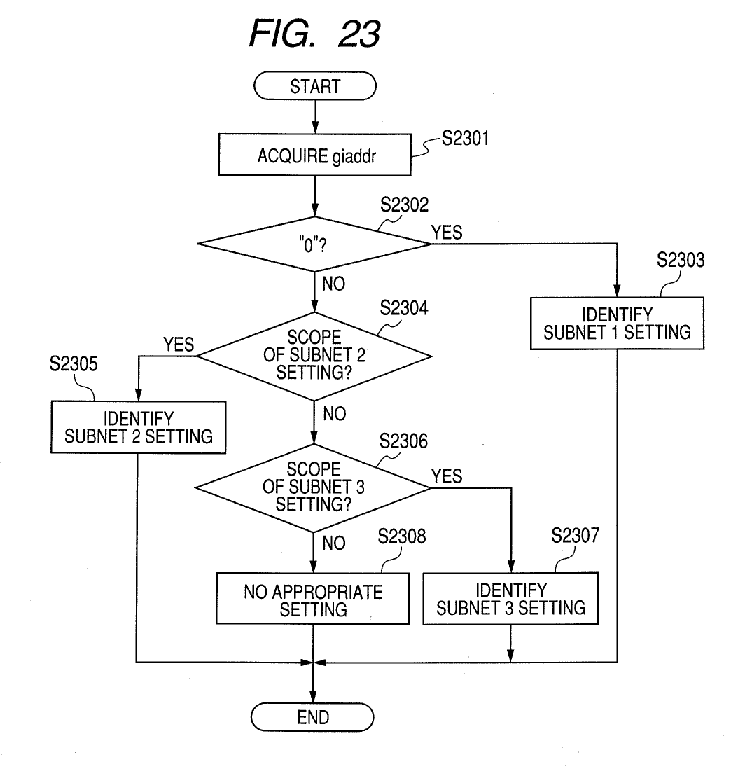

FIG. 23 is a flow chart illustrating in detail a process to be performed in a case where the setting information is identified in the step S2202 of the flow chart in FIG. 22.

Initially, in a step S2301, the value of the giaddr filed included in the DHCP DISCOVER message received in the step S2201 is acquired by the CPU 3001. Next, in a step S2302, it is judged by the CPU 3001 whether or not the value of the giaddr filed is “0”. Then, if it is judged that the value of the giaddr filed is “0”, this implies that the DHCP DISCOVER message is directly transmitted from the DHCP client which exists in the subnet same as that the DHCP server exists in. Consequently, in a step S2303, the subnet 1 setting 2101 is identified by the CPU 3001 as the setting information to be distributed. On the other hand, if it is judged in the step S2302 that the value of the giaddr filed is other than “0”, the flow advances to a step S2304. In the step S2304, it is judged by the CPU 3001 whether or not the value of the giaddr field is within the scope of the subnet 2 setting information. More specifically, it is judged in this step whether or not the network address of the giaddr field coincides with the network address of the relevant scope. If it is judged in the step S2304 that the network address of the giaddr field coincides with the network address of the relevant scope (that is, “YES” in the step S2304), the flow advances to a step S2305. In the step S2305, the subnet 2 setting information 2102 is identified by the CPU 3001 as the setting information to be distributed. On the other hand, if it is judged in the step S2304 that the network address of the giaddr field does not coincide with the network address of the relevant scope (that is, “NO” in the step S2304), the flow advances to a step S2306. In the step S2306, it is further judged by the CPU 3001 whether or not the value of the giaddr is within the scope of the subnet 3 setting information. Then, if it is judged that the value of the giaddr is within the scope of the subnet 3 setting information (that is, “YES” in the step S2306, the flow advances to a step S2307. In the step S2307, the subnet 3 setting information 2103 is identified as the setting information to be distributed. On the other hand, if it is judged in the step S2306 that the value of the giaddr is not within the scope of the subnet 3 setting information (that is, “NO” in the step S2306), the flow advances to a step S2308 to end the process without identifying the setting information.

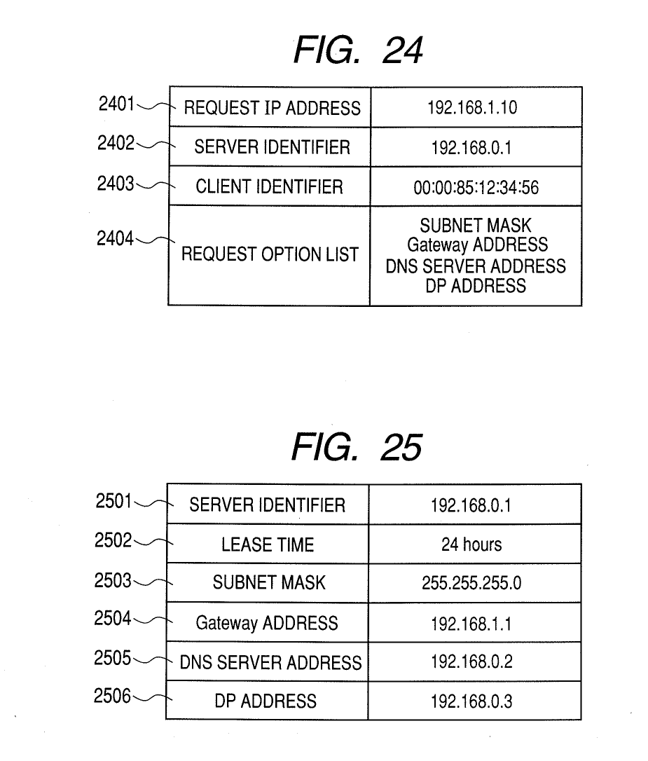

FIG. 24 is a diagram illustrating an example of the options field 301 of the DHCP REQUEST message which is received by the DHCP server in the step S2207 of the flow chart illustrated in FIG. 22. In FIG. 24, a request IP address 2401, a server identifier 2402, a client identifier 2403 and a request option list 2404 are described in the options field 301. More specifically, the IP address designated in the yiaddr field of the DHCP OFFER message is set to the request IP address 2401, the IP address of the DHCP server is set to the server identifier 2402, the MAC (Media Access Control) address of the DHCP client is set to the client identifier 2403, and the list of the setting information requested by the DHCP client is set to the request option list 2404. In the present embodiment illustrated in FIG. 24, the request option list 2404 includes the subnet mask, the Gateway address, the DNS server address and the DP address.

FIG. 25 is a diagram illustrating an example of the options field 301 of the DHCP ACK message which is transmitted by the DHCP server in the step S2210 of the flow chart illustrated in FIG. 22. In FIG. 25, the options field 301 includes a server identifier 2501, a lease time 2502, a subnet mask 2503, a Gateway address 2504, a DNS server address 2505 and a DP address 2506. More specifically, the IP address of the DHCP server is set to the server identifier 2501, the lease time is set to the lease time 2502, the subnet mask is set to the subnet mask 2503, the Gateway address is set to the Gateway address 2504, the DNS server address is set to the DNS server address 2505, and the address of the DP is set to the DP address 2506.

Subsequently, a process of registering the device information of the image forming apparatus 104 to the DP 102 will be described. The image forming apparatus 104 operates as the DHCP client, and the DHCP server 101 performs the processes of the flow charts illustrated in FIGS. 22 and 23. Consequently, the IP address of the DP 102 is received in addition to the IP address of the image forming apparatus 104 itself.

In a case where the image forming apparatus 104 starts its operation or the device information varies, the image forming apparatus 104 notifies the DP 102 of its existence by transmitting in unicast a Hello message of XML (eXtensible Markup Language) format as illustrated in FIG. 7 to the DP 102.

The Hello message illustrated in FIG. 7 includes a header section 701 enclosed by a <Header> tag and a body section 702 enclosed by a <Body> tag, and the whole of the Hello message is enclosed by an <Envelope> tag. Such a structure is common to all the massages to be used in the present embodiment.

The header section 701, which acts as a common header which does not depend on the content of the message, includes an <Action> tag, a <MessageID> tag and a <To> tag. Here, it should be note that the <Action> tag is to identify a kind of message, the <MessageID> tag is to uniquely identify the message, and the <To> tag is to identify a transmission destination of the message. On the other hand, the structure of the body section 702 varies according to the content of the message. In FIG. 7, a <Hello> tag exists immediately below a <Body> tag, and the message of the <Hello> tag is the Hello message. Further, the <Hello> tag includes an <EndpointReference> tag, a <Types> tag, an <XAddrs> tag, and a <MetadataVersion> tag. Furthermore, the <EndpointReference> tag includes an <Address> tag which has the address information for identifying the device, the <Types> tag has the type information of the device, the <XAddrs> tag has the URL for acquiring the device information, and the <MetadataVersion> tag has the version of the device information.

The DP 102 extracts, from the Hello message, the value of the <Address> tag in the <EndpointReference> tag as the UUID for globally identifying the device, extracts the value of the <Types> tag as the device type, extracts the value of the <MetadataVersion> tag as the version of the device information, and further extracts the value of the <XAddrs> as the URL for acquiring the device information. Then, the DP 102 stores the extracted information in the device information holding unit 514. At the same time, the DP 102 stores the IP address of the transmission source of the Hello message in the device information holding unit 514.

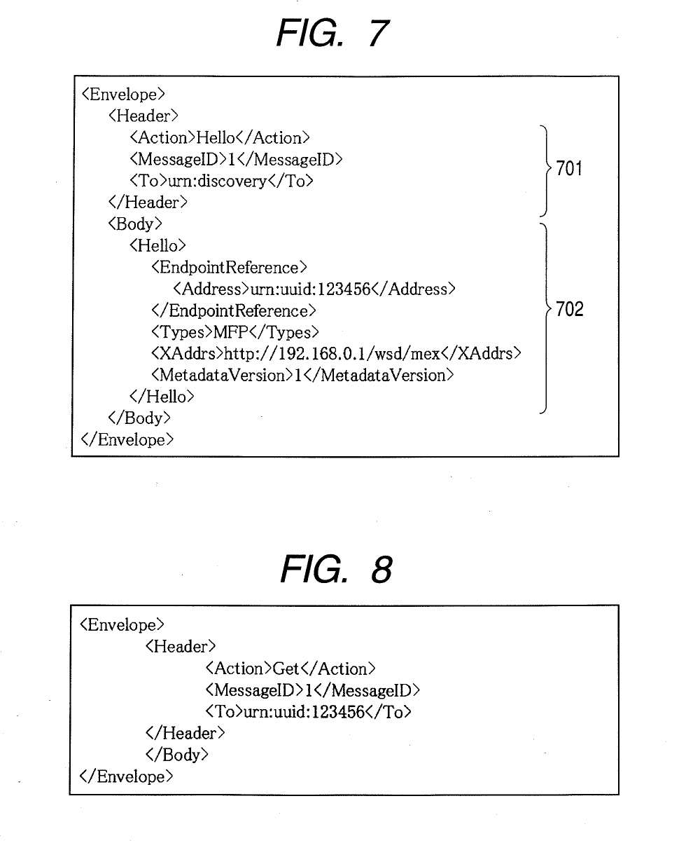

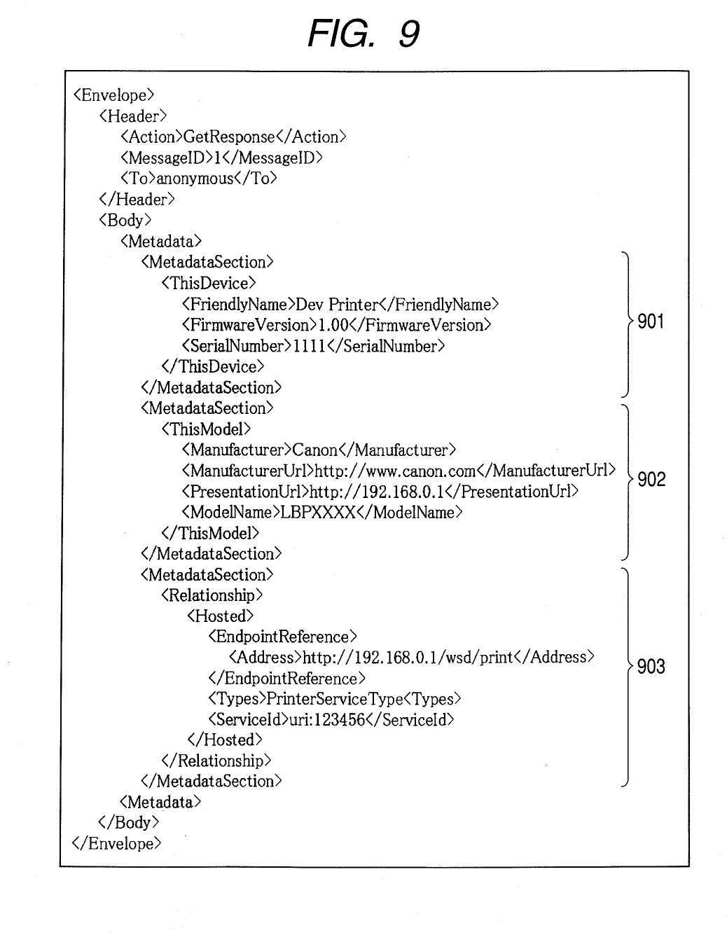

After then, the DP 102 transmits in unicast a Get message of XML format as illustrated in FIG. 8 to the URL described in the <XAddrs>. Here, it should be noted that the Get message illustrated in FIG. 8 is the message which includes only the header section. More specifically, an <Action> tag in the header section indicates that this message is the Get message.

If the Get message is received, the device information transmission unit 535 of the image forming apparatus 104 transmits a Get Response message as illustrated in FIG. 9.

In the Get Response message illustrated in FIG. 9, the body section has the device information indicated by a <Metadata> tag. The <Metadata> tag includes Metadata Sections 901, 902 and 903 each of which is enclosed by a <MetadataSection> tag. Incidentally, a kind of information of each Metadata Section is designated by the tag immediately below the <MetadataSection> tag. More specifically, the Metadata Section 901 includes a <ThisDevice> tag in which the information different for each device is stored. Further, a <FriendlyName> tag indicates the name of the device, a <FirmwareVersion> tag indicates the firmware version of the device, and a <SerialNumber> tag indicates the serial number of the device. The Metadata Section 902 includes a <ThisModel> tag in which the information different for each model of the device is stored. Further, a <Manufacturer> tag indicates the manufacturer of the device, a <ManufacturerUrl> tag indicates the URL of the device manufacturer, a <PresentationUrl> tag indicates the URL of the information of the device, and a <ModelName> tag indicates the model name of the device. The Metadata Section 903 includes a <Relationship> tag in which the information concerning the internal service of the device is stored. In the present embodiment, the internal service implies a print service which is provided by the image forming apparatus. The <Relationship> tag includes a <Hosted> tag immediately below, and the <Hosted> tag further includes a <EndpointReference> tag, a <Types> tag and a <ServiceId> tag. Further, the <EndpointReference> tag includes an <Address> tag having the address information for using the service. The <Types> tag has the type information of the service, and the <ServiceId> tag has the identifier for identifying the service.

The value of the <FriendlyName> tag and the value of the <ModelName> tag are extracted from the received device information by the DP 102 respectively as the device name and the model name, and the extracted values are stored in the device information holding unit 514.

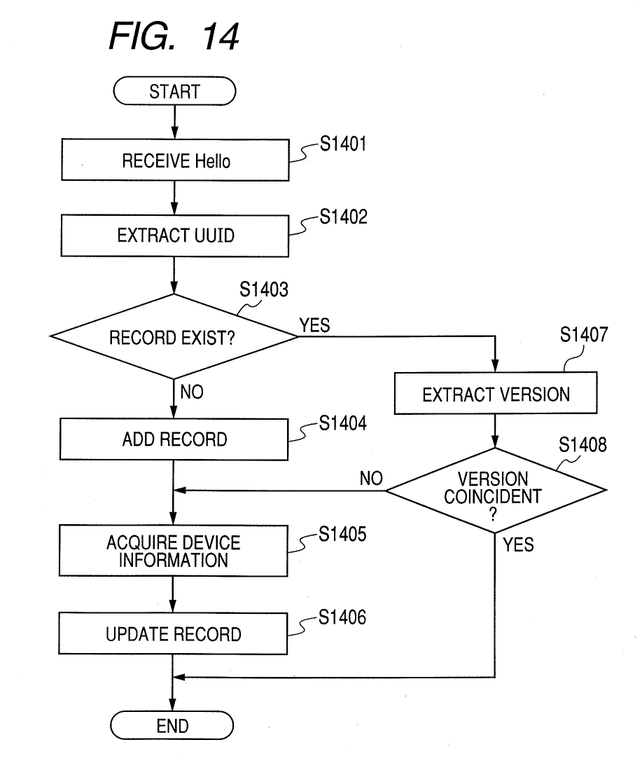

FIG. 14 is a flow chart illustrating a process to be performed in a case where the DP 102 registers the device information to the device information holding unit 514. That is, FIG. 14 indicates the flow of registering the above device information. Here, it should be noted that the respective steps of the flow chart illustrated in FIG. 14 are performed if the CPU 3001 of the DP 102 processes the program stored in the ROM 3002.

In a step S1401, the Hello message transmitted from the image forming apparatus is received by the DP 102 via the NIC 3008. Next, in a step S1402, the UUID is extracted from the received Hello message by the CPU 3001. Then, in a step S1403, it is judged by the CPU 3001 whether or not a record having the UUID same as the extracted UUID exists in the device information holding unit 514. If it is judged that the record does not exist, the flow advances to a step S1404. In the step S1404, the record is newly added to the device information of FIG. 6 held in the device information holding unit 514. Subsequently, in a step S1405, the Get message is transmitted from the DP 102 to the image forming apparatus to acquire the device information. Then, in a step S1406, the record added to the device information holding unit 514 is updated by the CPU 3001. On the other hand, if it is judged in the step S1403 that the record exists, the flow advances to a step S1407. In the step S1407, the version information is extracted from the received Hello message by the CPU 3001. Next, in a step S1408, it is judged by the CPU 3001 whether or not the version information in the record of which the UUID is coincident is the same as the version information extracted in the step S1407. If it is judged that the version information is different from the extracted version information, the flow advances to the steps S1405 and S1406 to update the device information. On the other hand, if it is judged that the version information is the same as the extracted version information, the process ends immediately.

Subsequently, a process in which the device information registered in the DP 102 is deleted by the image forming apparatus 104 will be described.

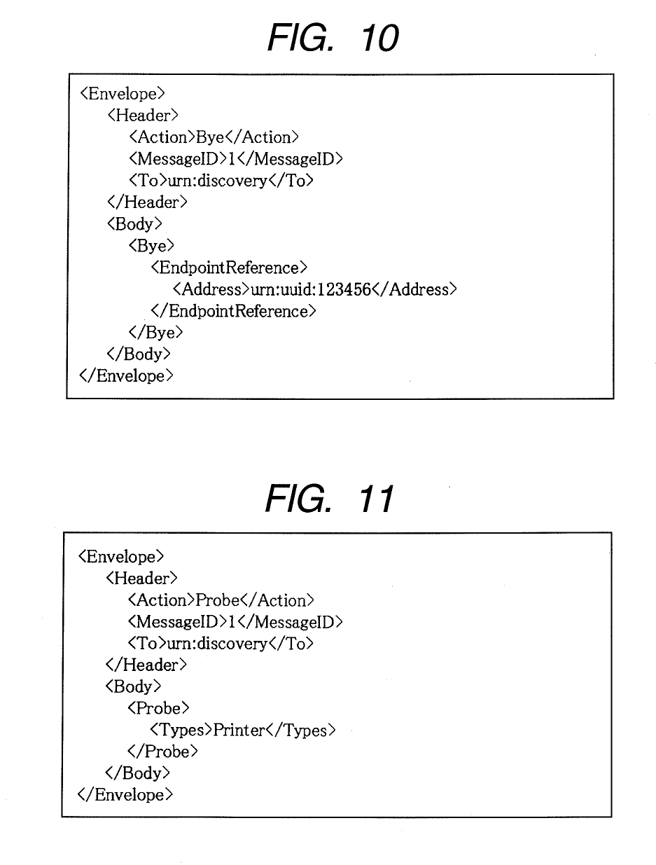

If the operation of the image forming apparatus 104 stops (for example, if the image forming apparatus 104 is shut down), the image forming apparatus 104 transmits in unicast a Bye message as illustrated in FIG. 10 to the DP 102.

In the Bye message illustrated in FIG. 10, a <Bye> tag is included in the body section so that this message indicates the Bye message. Further, the <Bye> tag includes an <EndpointReference> tag, and the <EndpointReference> tag further includes an <Address> tag having the address information for identifying the device.

The UUID information is extracted from the Bye message by the DP 102, and thus the corresponding device information is deleted from the device information holding unit 514.

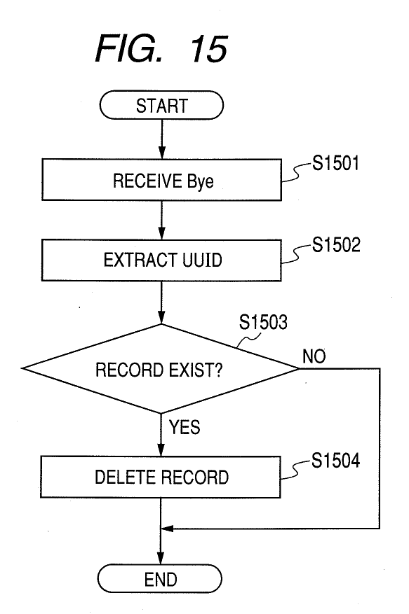

FIG. 15 is a flow chart illustrating a process to be performed in a case where the DP 102 deletes the device information from the device information holding unit 514. That is, FIG. 15 indicates the flow of deleting the above device information. Here, it should be noted that the respective steps of the flow chart illustrated in FIG. 15 are performed if the CPU 3001 of the DP 102 processes the program stored in the ROM 3002.

In a step S1501, the Bye message transmitted from the image forming apparatus is received by the DP 102 via the NIC 3008. Next, in a step S1502, the UUID is extracted from the received Bye message by the CPU 3001. Then, in a step S1503, it is judged by the CPU 3001 whether or not a record having the UUID same as the extracted UUID exists in the device information holding unit 514. If it is judged that the record exists, the flow advances to a step S1504. In the step S1504, the record is deleted from the device information holding unit 514 by the CPU 3001. On the other hand, if it is judged in the step S1503 that the record does not exist, the process ends immediately.

Subsequently, a process in which the client PC 103 searches for the image forming apparatus by using the DP 102 will be described. The client PC 103 operates as the DHCP client, and the DHCP server 101 performs the processes of the flow charts illustrated in FIGS. 22 and 23. As the result, the IP address of the DP 102 is received in addition to the IP address of the client PC 103 itself.

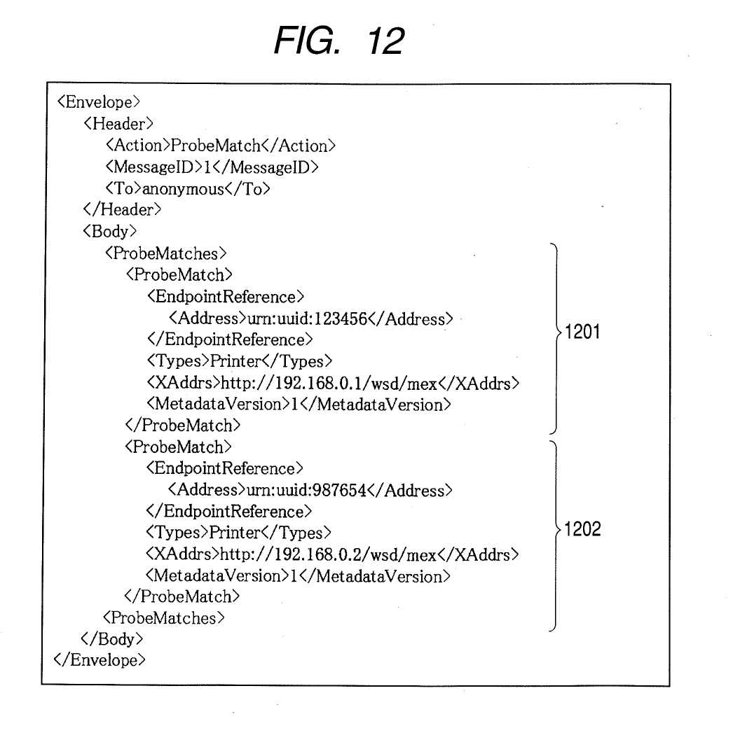

The client PC 103 transmits in unicast a Probe message of XML format as illustrated in FIG. 11 to the DP 102. In the Probe message illustrated in FIG. 11, a <Probe> tag is included in the body section so that this message indicates the Probe message. Further, the <Probe> tag includes a <Types> tag which is used to designate the type of the device that the user wishes to search for. In FIG. 11, the Probe message for searching for the device of which the type is a printer is illustrated.

If the Probe message is received by the DP 102, the <Types> tag is extracted to search for, in the device information holding unit 514, the device which conforms to the search condition, and a Probe Match message as illustrated in FIG. 12 is transmitted to the client PC 103. In the Probe Match message as illustrated in FIG. 12, a <ProbeMatches> tag is included in the body section so that this message indicates the Probe Match message. Here, Probe Match sections 1201 and 1202 respectively indicated by <ProbeMatch> tags are included in the <ProbeMatches> tag, and each of the Probe Match sections corresponds to one searched result. For example, FIG. 12 indicates the searched result that the two devices conform to the search condition. Incidentally, it should be noted that the structure of the Probe Match section is the same as the structure of the content of the <Hello> tag in the Hello message illustrated in FIG. 7.

In the client PC 103, the URL described by an <XAddrs> tag is extracted from the Probe Match message, and the Get message as illustrated in FIG. 8 is transmitted in unicast. It should be noted that, in the present embodiment, the URL is made of the IP address of the image forming apparatus 104, and the Get message is not transmitted to the DP 102 but is directly transmitted to the image forming apparatus 104. The Get Response message as illustrated in FIG. 9 is transmitted from the image forming apparatus 104 to the client PC 103, and then the necessary information is extracted by the client PC 103.

If plural searched results are included in the Probe Match message, the Get message is repeatedly transmitted from the client PC 103 so as to acquire all the device information.

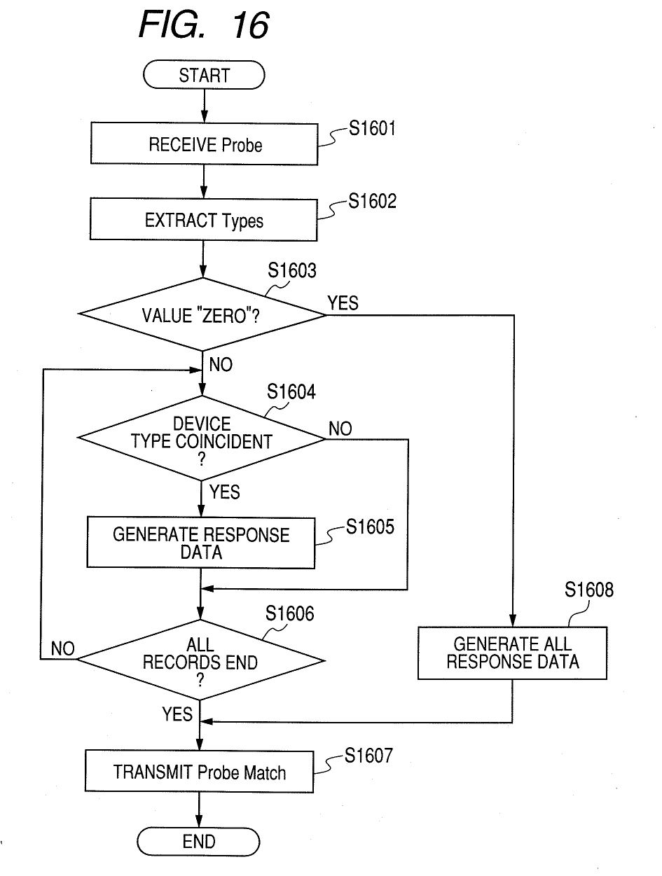

FIG. 16 is a flow chart illustrating a process to be performed in a case where the DP 102 searches for the device information. Here, it should be noted that the respective steps of the flow chart illustrated in FIG. 16 are performed if the CPU 3001 of the DP 102 processes the program stored in the ROM 3002.

In a step S1601, the Probe message transmitted from the client PC 103 is received by the DP 102 via the NIC 3008. Next, in a step S1602, the value of the <Types> tag in the received Probe message is extracted by the CPU 3001. Then, in a step S1603, it is judged by the CPU 3001 whether or not the value of the <Types> tag is “zero”. If it is judged that the value is not “zero”, the flow advances to a step S1604. In the step S1604, the records of the device information held in the device information holding unit 514 are searched by the CPU 3001 to judge whether or not the record having the same device type (value) as the extracted value exists. If it is judged that the record having the same device type as the extracted value exists (that is, if the device types are coincident), the flow advances to a step S1605. In the step S1605, the response data corresponding to the relevant record is generated by the CPU 3001. Then, in a step S1606, it is judged by the CPU 3001 whether or not confirmation for all the records ends. If it is judged that the confirmation ends, the flow advances to a step S1607. In the step S1607, the response data generated up to this time are united by the CPU 3001, the Probe Match message as illustrated in FIG. 12 is transmitted to the client PC 103, and the process ends. On the other hand, if it is judged in the step S1603 that the value of the <Types> tag is “zero”, the flow advances to a step S1608. In the step S1608, the response data corresponding to all the records are generated by the CPU 3001. Then, in the step S1607, the Probe Match message is transmitted to the client PC 103, and the process ends. Incidentally, in FIG. 16, the search condition included in the Probe message is the device type. However, another information such as a device name, a model name or the like may be used as the search condition.

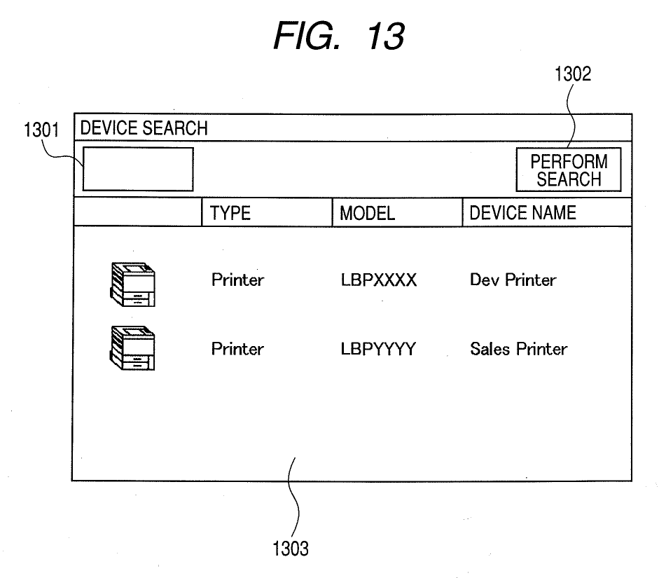

FIG. 13 is a diagram illustrating an example of a UI in a case where the client PC 103 searches for the image forming apparatus, and the screen illustrated in FIG. 13 is displayed on the CRT 3010 of the client PC 103. In FIG. 13, an area 1301 is the area for designating a type of device to be searched. More specifically, key words such as “MFP”, “Printer” and the like can be designated in the area 1301. If any data is not input to the area 1301, all the image forming apparatuses are searched resultingly. Further, if a button 1302 is depressed, searching is performed to the DP 102 as described above. Then, the searched result is displayed in an area 1303. More specifically, the types, the model names and the device names of the devices are simultaneously displayed.

As described above, according to the present embodiment, it is possible to search for the device even if the relevant device exists over the subnet. Further, since it becomes possible to easily register the device search server to the client PC and the device, it is possible to reduce a labor hour for the system administrator and the user. That is, in case of distributing the address from the DHCP server to the client PC and the device, since it is possible for the DHCP server to also distribute the address of the device search server, it becomes unnecessary to again register the address of the device search server to the client PC and the device.

### Second Embodiment

Next, an example of another system configuration will be described as the second embodiment of the present invention.

In the present embodiment, the device information to be held in the device information holding unit 514 of the DP 102 is updated not based on reception of the notification from the image forming apparatus but based on reception of a notification from the DHCP server.

Incidentally, it should be noted that the network configuration of the present embodiment is the same as that in the first embodiment illustrated in FIG. 1.

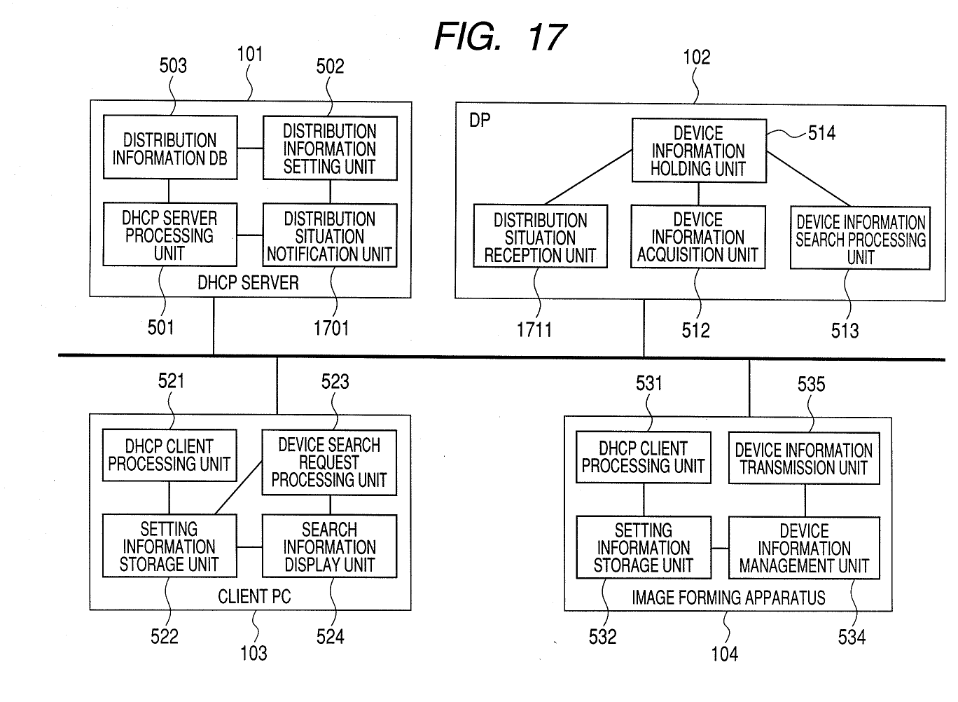

FIG. 17 is a block diagram illustrating software constitutions of the DHCP server 101, the DP 102, the client PC 103 and the image forming apparatus 104 according to the present embodiment. Here, it should be noted that the block having the function same as that described in the first embodiment is denoted by the numeral same as that described in the first embodiment, and thus the description thereof will be omitted.

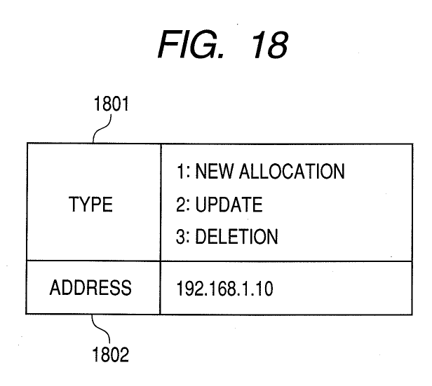

In FIG. 17, a distribution situation notification unit 1701 of the DHCP server 101 notifies the DP 102 of a situation of distribution of the IP address and the setting information to the DHCP client, in such a format as illustrated in FIG. 18. It should be noted that the distribution situation notification unit 1701 performs the notification at timing of transmitting the DHCP ACK message (S2004, S2006 in FIG. 2), at timing of receiving the DHCP RELEASE message (S2007 in FIG. 2), and at timing of releasing the allocation of the IP address without receiving the DHCP REQUEST message within the lease time.

A distribution situation reception unit 1711 of the DP 102, which received the notification from the DHCP server 101, performs, based on a kind of received notification, a process by using the device information held in the device information holding unit 514. If it is necessary to acquire the device information, the device information acquisition unit 512 transmits a device information acquisition request to the image forming apparatus 104, and then holds the returned device information in the device information holding unit 514.

The image forming apparatus 104 does not have a unit corresponding to the device information notification unit 533 as in the first embodiment. Consequently, even if the IP address of the DP 102 is distributed from the DHCP server 101, the image forming apparatus 104 does not directly notify the DP 102 of the distributed IP address.

FIG. 18 is the diagram illustrating the format of the notification data to be transmitted from the DHC server 101 to the DP 102. In FIG. 18, a type 1801 includes items 1, 2 and 3. In the type 1801, the item 1 indicates that the IP address has been newly allocated by transmitting the DHCP ACK message (S2004), the item 2 indicates that the use of the IP address has been updated by transmitting the DHCP ACK message (S2006), and the item 3 indicates that the allocation of the IP address was released by receiving the DHCP RELEASE message or without receiving the DHCP REQUEST message within the lease time. Besides, the distributed IP address is set to an address 1802.

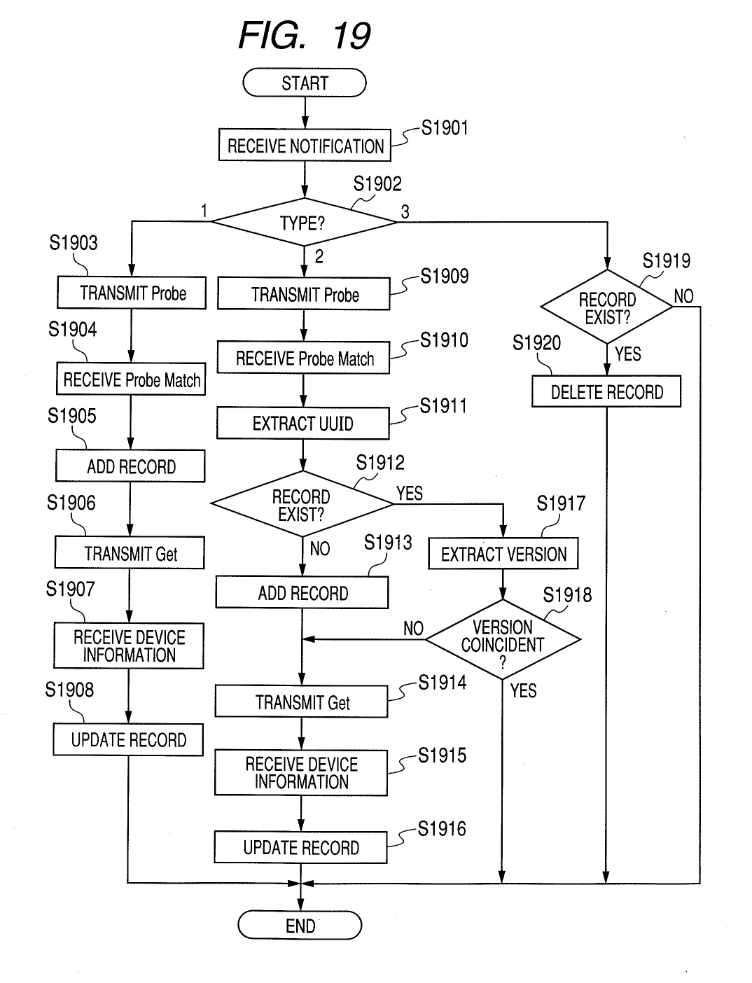

FIG. 19 is a flow chart illustrating a process to be performed by the DP 102 in a case where the distribution situation reception unit 1711 of the DP 102 receives the notification from the DHCP server 101. Here, it should be noted that the respective steps of the flow chart illustrated in FIG. 19 are performed if the CPU 3001 of the DP 102 processes the program stored in the ROM 3002.

First, such a notification message as illustrated in FIG. 18 is received by the DP 102 via the NIC 3008 in a step S1901, and a type of notification message is analyzed and judged in a step S1902. That is, if it is judged that the type is “1”, the flow advances to a step S1903. In the step S1903, a Probe message is transmitted from the DP 102 to the IP address included in the notification message via the NIC 3008. Then, a Probe Match message as the response for the Probe message is received in a step S1904, and a new record is added by the CPU 3001 to the device information holding unit 514 in response to the received Probe Match message in a step S1905. Subsequently, a Get message is transmitted via the NIC 3008 in a step S1906, the device information as the response for the Get message is acquired in a step S1907, the record added to the device information holding unit 514 is updated by the CPU 3001 in a step S1908, and then the process ends.

Further, if it is judged in the step S1902 that the type is “2”, the flow advances to a step S1909. In the step S1909, the Probe message is transmitted from the DP 102 to the IP address included in the received notification message via the NIC 3008. Then, the Probe Match message as the response for the Probe message is received in a step S1910, and the UUID is extracted by the CPU 3001 from the Probe Match message in a step S1911. Then, in a step S1912, it is judged by the CPU 3001 whether or not a record having the UUID same as the extracted UUID exists in the device information holding unit 514. If it is judged that the record does not exist, the flow advances to a step S1913. In the step S1913, a record is newly added to the device information holding unit 514 by the CPU 3001. Then, the Get message is transmitted in a step S1914, the device information as the response for the Get message is acquired in a step S1915, the record added to the device information holding unit 514 is updated by the CPU 3001 in a step S1916, and then the process ends. On the other hand, if it is judged in the step S1912 that the record exists, the flow advances to a step S1917. In the step S1917, the version information is extracted from the Probe Match message by the CPU 3001. Next, in a step S1918, it is judged by the CPU 3001 whether or not the version information extracted in the step S1917 is the same as the version information in the record of which the UUID is coincident. If it is judged that the version information is not the same, the flow advances to the step S1914. In the step S1914, the device information is updated by the CPU 3001. On the other hand, if it is judged that the version information are the same, the process ends immediately.

Furthermore, if it is judged in the step S1902 that the type is “3”, the flow advances to a step S1919. In the step S1919, it is judged by the CPU 3001 whether or not a record having the IP address included in the notification message exists in the device information held in the device information holding unit 514. If it is judged that the record exists, the flow advances to a step S1920. In the step S1920, the record is deleted from the device information holding unit 514 by the CPU 3001. On the other hand, if it is judged that the record does not exist, the process ends immediately.

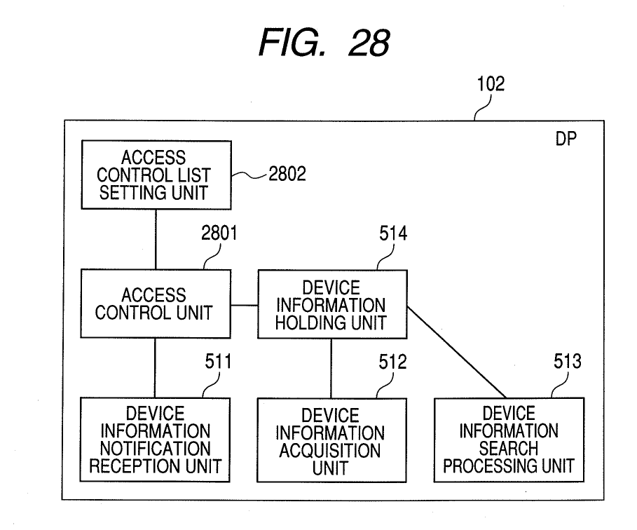

Incidentally, in the present embodiment, the apparatuses capable of deleting the device information held in the device information holding unit 514 can be limited. In other words, it is possible to set that only a specific apparatus can delete the device information held in the device information holding unit 514 of the DP 102. FIG. 28 is a block diagram illustrating a software constitution of the DP 102 in such a case. In FIG. 28, if the notification message as illustrated in FIG. 18 is received by an access control unit 2801, it is judged whether or not to process the notification message, according to an access control list created by an access control list setting unit 2802. Here, it should be noted that, if a desired IP address is input by the user via the KB 3009b, the access control list is created based on the input IP address. Alternatively, the access control list may be created by receiving IP address information via a network.

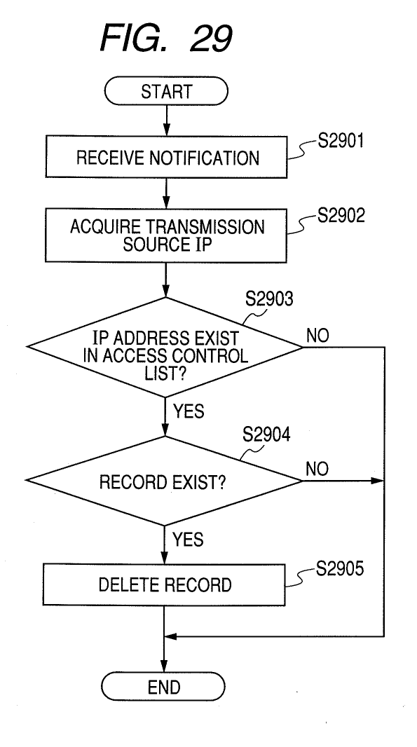

FIG. 29 is a flow chart illustrating a process to be performed in a case where the distribution situation reception unit 1702 of the DP 102 receives from the DHCP server 101 a notification that the type of notification message is “3”. Here, it should be noted that the respective steps of the flow chart illustrated in FIG. 29 are performed by the CPU 3001 of the DP 102.

In FIG. 29, the notification indicating that the type is “3” is first received by the DP 102 in a step S2901, and the IP address of the transmission source of the received notification is acquired by the CPU 3001 in a step S2902. Here, it should be noted that transmission and reception of the notification message illustrated in FIG. 18 is performed by using IP communication, and the IP address is acquired from an IP header added in front of the notification message. Next, in the step S2903, it is judged by the CPU 3001 whether or not the acquired IP address exists in the access control list. If it is judged that the acquired IP address exists in the access control list, the flow advances to a step S2904. Then, in the step S2904, it is judged by the CPU 3001 whether or not a record having the IP address included in the notification message exists in the device information held in the device information holding unit 514. If it is judged that the record exists, the flow advances to a step S2905. In the step S2905, the record is deleted by the CPU 3001, and the process ends. On the other hand, if it is judged in the step S2903 that the acquired IP address does not exist in the access control list, and if it is judged in the step S2904 that the record does not exist, the process ends immediately.

In the above constitution, the apparatus capable of deleting the device information held in the DP 102 can be limited only to, for example, the DHCP server 101.

As described above, according to the second embodiment, it becomes unnecessary for the client PC 103 or the image forming apparatus 104 to notify the DP 102 of own information. Therefore, even in the condition that the client PC or the image forming apparatus cannot notify the DP 102 of own information, the DHCP server instead of the client PC or the image forming apparatus can notify the DP 102 of the device information. For example, if the image forming apparatus cannot transmit the Bye message to the DP because the power supply of the image forming apparatus was turned off, the DHCP server can know the fact that the image forming apparatus cannot be used, because the an update of the IP address is not requested. In such a case, the DHCP server instead of the image forming apparatus can transmit a notification for requesting deletion of the information of the image forming apparatus from the device information of the DP 102. Therefore, the DP can manage more accurate device information even in such a condition.

### Third Embodiment

Next, the third embodiment of the present invention will be described.

It should be noted that, although only one DP is disposed on the network in the above-described embodiments, the DP is disposed for each of the subnets in the present embodiment.

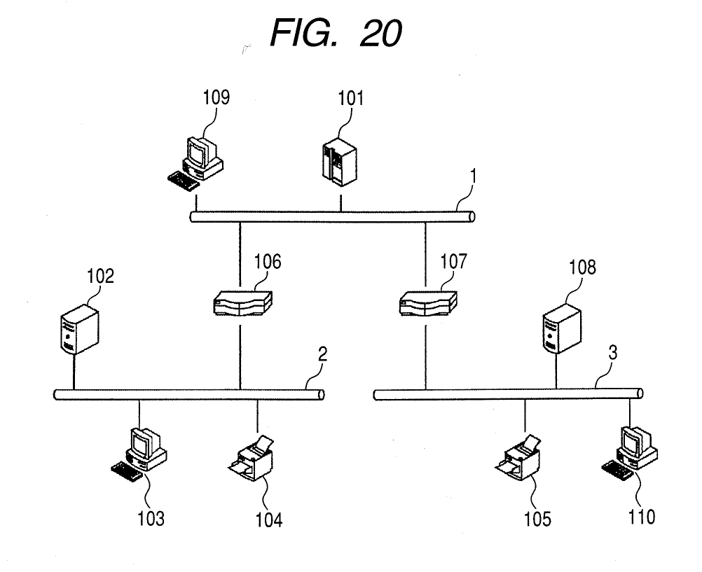

FIG. 20 is a diagram illustrating a configuration of a network device search system according to the present embodiment. In the network device search system illustrated in FIG. 20, a DHCP server 101 and a client PC 109 are connected to a subnet 1, a DP 102, a client PC 103 and an image forming apparatus 104 are connected to a subnet 2, and a DP 108, a client PC 110 and an image forming apparatus 105 are connected to a subnet 3. Further, the subnet 1 and the subnet 2 are mutually connected to each other via a router 106, and the subnet 1 and the subnet 3 are mutually connected to each other via a router 107. Thus, all the terminals connected to the subnets 1, 2 and 3 can mutually communicate resultingly.

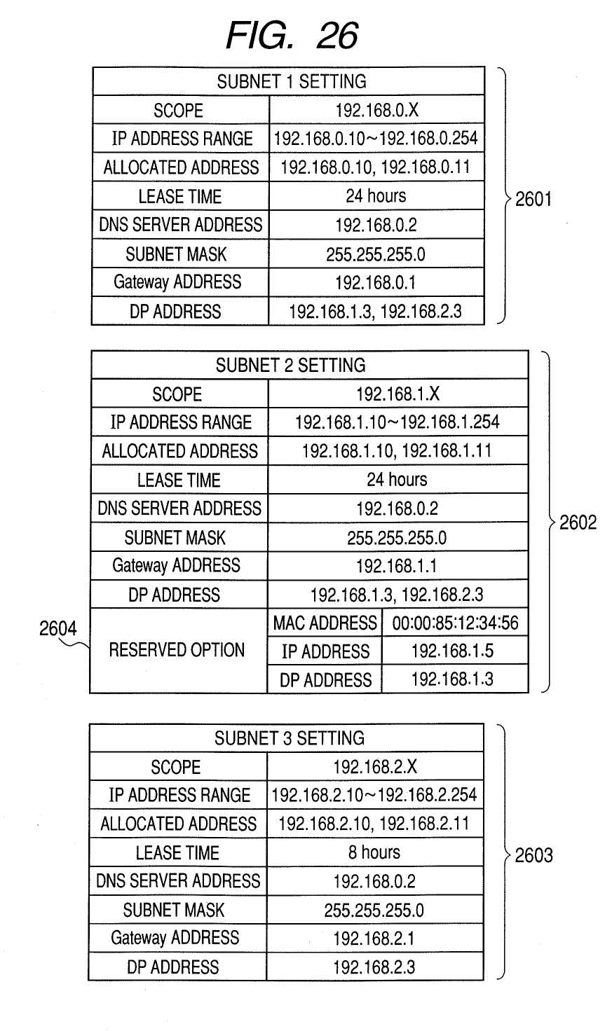

In the system configuration like this, according to the present embodiment, distribution setting as illustrated in FIG. 26 is performed by the distribution information setting unit 502 of the DHCP server 101. In FIG. 26, a reserved option 2604 exists in subnet 2 setting information 2602 in addition to the setting information of the first embodiment as illustrated in FIG. 21. The reserved option 2604 includes a MAC address, an IP address and a DP address. If the MAC address of the DHCP client which transmitted the DHCP REQUEST message coincides with any of the addresses included in the reserved option, the information described in this option is preferentially distributed. Incidentally, although only one reserved option is set in FIG. 26, plural reserved options can be set. In the present embodiment, for the reserved option 2604, the MAC address of the image forming apparatus 104 is set as the MAC address, the IP address fixedly distributed to the image forming apparatus 104 is set as the IP address, and the IP address of the DP 102 is set as the DP address. Moreover, the IP addresses of the DPs 102 and 108 are set as the address of the DP in subnet 1 setting information 2601, the IP addresses of the DPs 102 and 108 are set as the address of the DP in the subnet 2 setting information 2602, and the IP address of the DP 108 is set as the address of the DP in subnet 3 setting information 2603.

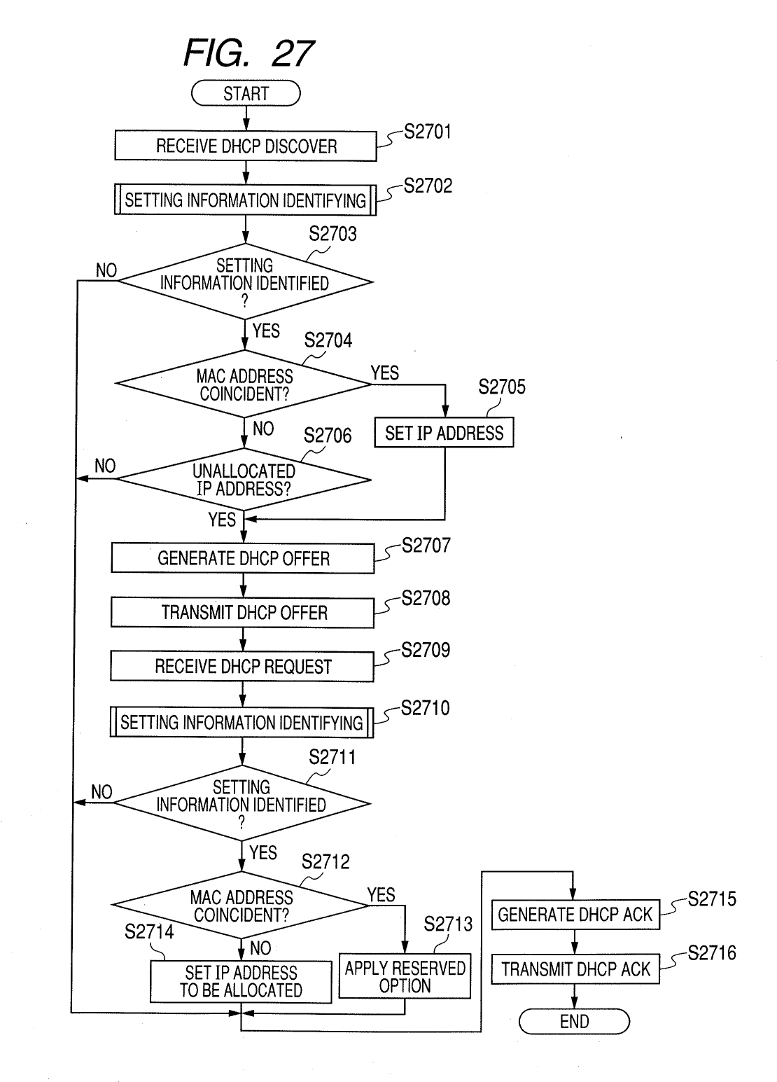

Subsequently, a process to be performed in a case where the DHCP server 101 distributes the setting information such as the IP address and the like to the DHCP client will be described with reference to a flow chart illustrated in FIG. 27. Here, it should be noted that the respective steps of the flow chart illustrated in FIG. 27 are performed if the CPU 3001 of the DHCP server 101 processes the program stored in the ROM 3002.

Initially, in a step S2701, the DHCP DISCOVER message transmitted by the DHCP client or the relay agent is received by the DHCP server 101. Then, in a step S2702, the setting information to be allocated is identified by the CPU 3001 in the method of the first embodiment illustrated in FIG. 23. In a step S2703, it is judged by the CPU 3001 whether or not the setting information is identified by the process in the step S2702. If it is judged that the setting information is not identified, the process ends. On the other hand, if it is judged that the setting information is identified, the flow advances to a step S2704. In the step S2704, it is judged by the CPU 3001 whether or not the client identifier included in the message coincides with the MAC address of the reserved option in the identified setting information. If it is judged that the client identifier coincides with the MAC address, the flow advances to a step S2705. In the step S2705, the IP address set in the reserved option is set to the yiaddr field in the DHCP OFFER message by the CPU 3001, and then the flow advances to a step S2707. On the other hand, if it is judged in the step S2704 that the client identifier does not coincide with the MAC address, the flow advances to a step S2706. In the step S2706, it is judged by the CPU 3001 whether or not an unallocated IP address (that is, the IP address which is not yet allocated) remains in the identified setting information. Then, if it is judged that the unallocated IP address does not remain, the process ends. On the other hand, if it is judged that the unallocated IP address remains, the flow advances to the step S2707. In the step S2707, the identified setting information is set by the CPU 3001 to a portion of the DHCP OFFER message to which any setting is not performed, whereby the DHCP OFFER message is generated. Here, if the IP address is not set to the yiaddr field in the step S2705, the IP address distributed is set to the yiaddr field. Then, in a step S2708, the generated DHCP OFFER message is transmitted to the DHCP client. Subsequently, in a step S2709, he DHCP REQUEST message transmitted by the DHCP client or the relay agent is received by the DHCP server 101. Next, in a step S2710, the setting information to be allocated is identified by the CPU 3001 in the method of the first embodiment illustrated in FIG. 23. In a step S2711, it is judged by the CPU 3001 whether or not the setting information is identified by the process in the step S2710. If it is judged that the setting information is not identified, the process ends. On the other hand, if it is judged that the setting information is identified, the flow advances to a step S2712. In the step S2712, it is judged by the CPU 3001 whether or not the client identifier included in the message coincides with the MAC address of the reserved option in the identified setting information. If it is judged that the client identifier coincides with the MAC address, the flow advances to a step S2713. In the step S2713, the setting information set in the reserved option is set to the DHCP ACK message by the CPU 3001. On the other hand, if it is judged in the step S2712 that the client identifier does not coincide with the MAC address, the flow advances to a step S2714. In the step S2714, it is set that the request IP address included in the DHCP REQUEST message has been allocated. Next, in a step S2715, the identified setting information is set by the CPU 3001 to a portion of the DHCP REQUEST message to which any setting is not performed, whereby the DHCP ACK message is generated. Then, in a step S2716, the generated DHCP ACK message is transmitted to the DHCP client, and the process ends.

By the above process, the IP address of the DP 102 is distributed to the image forming apparatus 104, and IP address of the DP 108 is distributed as the DP address to the image forming apparatus 105.

As a result, the image forming apparatus 104 comes to notify the DP 102 of its existence, and the image forming apparatus 105 comes to notify the DP 108 of its existence. After then, by performing the message exchange same as that in the first embodiment, the device information of the image forming apparatus 104 is held in the DP 102, and the device information of the image forming apparatus 105 is held in the DP 108.

On the other hand, the IP addresses of the DPs 102 and 108 are distributed as the DP address to the client PC 103. Then, the client PC 103 repeatedly performs the process same as that in the first embodiment to both the DPs 102 and 108, thereby enabling to acquire the device information of the image forming apparatuses 104 and 105. Further, the IP address of the DP 108 is distributed as the DP address to the client PC 110. Thus, the client PC 110 performs the process same as that in the first embodiment to the DP 108, thereby enabling to acquire the device information of the image forming apparatus 105. However, the client PC 110 cannot acquire the device information of the image forming apparatus 104 because it is impossible to know existence of the DP 102. Consequently, it is possible to control the client PC on the subnet 2 to acquire the device information of the image forming apparatuses existing on all the subnets and to control the client PC on the subnet 3 to acquire only the device information of the image forming apparatus existing on the subnet 3. Moreover, in FIG. 26, it is set to distribute the IP addresses of the DPs 102 and 108 to the DHCP client on the subnet 1 on which a DP does not exist. Consequently, the client PC 109 can acquire the device information of the image forming apparatuses 104 and 105, as well as the client PC 103.

### Other Embodiments

The present invention may be applied to a system including plural devices or to an apparatus including a single device.

Further, in the present invention, the storage medium storing the computer program codes of software for achieving the functions of the flow charts of the above embodiments may be supplied to a system or an apparatus. Thus, the present invention can be achieved, if a computer {CPU or MPU (microprocessor unit)} in the system or the apparatus reads and performs the program codes stored in the storage medium.

In this case, since the program codes themselves read from the storage medium achieve the functions of the above embodiments, the storage medium storing these program codes constitutes the present invention.

As the storage medium for supplying the program codes, for example, a flexible disk, a hard disk, an optical disk, a magnetooptical disk, a CR-ROM (compact disk read only memory), a CD-R (compact disk recordable), a DVD-ROM (digital versatile disk read only memory), a magnetic tape, a nonvolatile memory card, a ROM (read only memory), or the like can be used.

This application claims priority from Japanese Patent Application No. 2007-330953 filed Dec. 21, 2007, which is hereby incorporated by reference herein.

1. An information processing apparatus comprising:
a management unit adapted to manage plural network addresses;
an allocation unit adapted to, according to a request from an apparatus newly connected to a network, allocate, from among the network addresses managed by the management unit, the network address not allocated to other apparatus;
a storage unit adapted to store the network address of a search server of performing a search according to a search request for searching for a device on the network and of responding to the search request by a searched result; and
a transmission unit adapted to transmit the network address allocated by the allocation unit and the network address stored in the storage unit to the apparatus.

2. An information processing apparatus comprising:
a management unit adapted to manage plural network addresses;
an allocation unit adapted to, according to a request from an apparatus newly connected to a network, allocate, from among the network addresses managed by the management unit, the network address not allocated to other apparatus;
a storage unit adapted to store the network address of a search server of performing a search according to a search request for searching for a device on the network and of responding to the search request by a searched result; and
a transmission unit adapted to transmit the network address allocated by the allocation unit to the apparatus and the search server.

3. An information processing apparatus according to claim 1, wherein the transmission unit transmits information indicating a usable period during which the apparatus can use the network address allocated by the allocation unit.

4. An information processing apparatus according to claim 3, further comprising:
an update unit adapted to update the usable period in a case where an update request is received from the apparatus before the usable period lapses, and to release the allocation of the network address in a case where the update request is not received from the apparatus even if the usable period lapses; and
a notification unit adapted to notify, in a case where the allocation of the network address is released by the update unit, the search server that the network address came to be not used.

5. An information processing apparatus according to claim 1, wherein
the storage unit stores the respective network addresses of the plural search servers, and
the transmission unit switches, according to the apparatus, which of the network addresses of the plural search servers should be transmitted.

6. An information processing apparatus according to claim 1, wherein the information processing apparatus includes a DHCP (Dynamic Host Configuration Protocol) server, and the network address includes an IP (Internet Protocol) address.

7. An information processing apparatus according to claim 1, wherein the apparatus includes either a client computer or a device used by the client computer.

8. A device which is connected to a network, comprising:
a transmission unit adapted to transmit a request on the network so as to acquire a network address of the device from an information processing apparatus provided on the network;
a reception unit adapted to receive, from the information processing apparatus, the network address of the device and a network address of a search server of performing a search according to a search request for searching for the device on the network and of responding to the search request by a searched result; and
a second transmission unit adapted to transmit device information of the device itself to the search server, based on the network address of the search server received by the reception unit.

9. An information processing apparatus which is connected to a network, comprising:
a transmission unit adapted to transmit a request on the network so as to acquire a network address of the information processing apparatus from a server provided on the network;
a reception unit adapted to receive, from the server, the network address of the information processing apparatus and a network address of a search server of performing a search according to a search request for searching for a device on the network and of responding to the search request by a searched result; and
a second transmission unit adapted to transmit the search request to the search server based on the network address of the search server received by the reception unit.

10. A control method for an information processing apparatus, comprising the steps of:
managing plural network addresses, and, according to a request from an apparatus newly connected to a network, allocating, from among the plural network addresses, the network address not allocated to other apparatus;
storing in a storage unit the network address of a search server of performing a search according to a search request for searching for a device on the network and of responding to the search request by a searched result; and
transmitting the allocated network address and the network address stored in the storage unit to the apparatus.

11. A computer-readable storage medium storing a computer program to cause an information processing apparatus to perform the steps of:
managing plural network addresses, and, according to a request from an apparatus newly connected to a network, allocating, from among the plural network addresses, the network address not allocated to other apparatus;
storing in a storage unit the network address of a search server of performing a search according to a search request for searching for a device on the network and of responding to the search request by a searched result; and
transmitting the allocated network address and the network address stored in the storage unit to the apparatus.
